(19) United States
(12) Patent Application Publication
(10) Pub. No.: US 2010/0272962 A1
(43) Pub. Date: Oct. 28, 2010

(54) REFLECTIVE SUBSTRATE SURFACE SYSTEM, REFLECTIVE ASSEMBLY, AND METHODS OF IMPROVING THE VISIBILITY OF A SUBSTRATE SURFACE

(75) Inventor: Christopher J. Davies, Plymouth Meeting, PA (US)

Correspondence Address: BUCHANAN INGERSOLL & ROONEY PC, P.O. BOX 1404, ALEXANDRIA, VA, 22313-1404, US

(73) Assignee: Potters Industries Inc., Malvern, PA (US)

(21) Appl. No.: 12/428,117

(22) Filed: Apr. 22, 2009

(51) Int. Cl. B32B 3/26; B05D 5/06

(52) U.S. Cl. 428/161; 427/162

(57) ABSTRACT

A method of coating a substrate surface to improve the visibility of the surface includes the steps of a) applying a first layer of binder to a substrate; b) applying a first layer of optical elements onto the first layer of binder to partially embed the first layer of optical elements into the first layer of binder; c) applying a second layer of binder to cover the first layer of optical elements, wherein the first layer of optical elements defines a plurality of undulations in the second layer of binder; and d) applying a second layer of optical elements onto the second layer of binder to partially embed the second layer of optical elements in the second layer of binder such that the second layer of optical elements has an exposed-lens surface portion and an embedded-lens surface portion.

### FIELD OF THE INVENTION

This invention relates to articles for use in improving the visibility of a surface, such as reflective substrate surface elements and other reflective articles, comprising microspheres as well as methods of making reflective substrate surface systems.

### BACKGROUND OF THE INVENTION

Reflective elements are incorporated in traffic signs, pavement markings and apparel. Pavement markings, for example such as those on the centerline and edge of a roadway, provide visual guidance for motor vehicle drivers. The visibility provided by these pavement markings is particularly vital for night time navigation.

U.S. Pat. No. 6,127,020 to Bacon, Jr. et al. teaches that such pavement markings typically include glass microspheres that are partially embedded in a binder layer containing reflective pigment particles such as titanium dioxide (TiO₂) or lead chromate (PbCrO₄). As light from the headlamp of a vehicle impinges upon the microsphere, it is refracted towards the reflective pigment. Refraction as used herein refers to the deflection of light from its original pathway. The light passes through the optical element and is scattered by the pigment-containing pavement paint. A portion of the scattered light is directed back through the optical element and is directed back along the original path towards the driver, increasing the visibility of the markings. This results in a retroreflective effect wherein the most intense light travels back along the illumination axis, which is the centerline between the headlamp and the microsphere, and the light becomes dimmer the farther it is viewed from the illumination axis. Retroreflection as used herein refers to the tendency of light to travel back along its original pathway upon hitting certain surfaces.

The intensity of the light returning to the driver depends upon, among other things, the effective refractive index of the pavement marking. Refractive index as used herein refers to the magnitude by which the speed of light is reduced within a medium. The microspheres have an inherent refractive index; however, U.S. Pat. No. 6,796,740 to Chiron et al. explains that a lower effective refractive index will result if a film of water from recent rainfall has covered the pavement marking. The angle of incidence with which the light impinges upon the microsphere also bears upon the intensity of the light reaching the driver's eyes. Furthermore, retroreflectivity may diminish as traffic erodes the pavement marking surface, if the traffic causes the microspheres to become dislodged from the binder.

It is highly desirable to provide a reflective marking system that is adaptable to various substrate conditions. Additionally, there is a need for a durable reflective marking that provides a continued and consistent source of reflectivity as the system erodes over time.

### SUMMARY OF THE INVENTION

The present invention provides a marking system adapted for coating a surface of a substrate. The substrate may be, but is not limited to, a road, sign, or guard rail. According to a first aspect of the invention, there is provided a reflective marking system wherein a substrate is covered by a reflective marking. The reflective marking system comprises a first layer of binder wherein the bottom surface of the binder is adapted for binding to the surface of the substrate, or a previously applied coating, such as a primer or tape, on the substrate. A first layer of optical elements is partially embedded in the top surface of the first layer of binder. A second layer of binder covers the first layer of optical elements such that the first layer of optical elements defines a plurality of undulations in the second layer of binder. A second layer of optical elements is partially embedded in the top surface of the second layer of binder and has an exposed-lens surface portion.

In another embodiment, the invention provides a reflective element which comprises a glass microsphere core member and an adherent coating. The core member has a generally spherical periphery which is defined by a first portion of the periphery and a second portion of the periphery. An adherent coating extends over the entire periphery and comprises a first layer of binder extending over the first portion of the periphery and a second layer of binder extending over a second portion of the periphery. The core member has substantially no exposed-lens surface portion (i.e., an uncoated peripheral portion of the core member). The coating further comprises a layer of light-returning glass microspheres which are smaller in diameter than the core member. The smaller glass microspheres are partially embedded in the second layer of binder and have an exposed-lens surface portion.

In yet another embodiment, the invention is a process for producing a reflective marking system on the surface of a substrate comprising the steps of applying a first layer of binder to the surface of the substrate, applying a first layer of optical elements onto the first layer of binder to partially embed the first layer of optical elements in the first layer of binder wherein the first layer of optical elements has a partially exposed-lens surface portion, applying a second layer of binder to the first layer of optical elements to cover the exposed-lens surface portion of the first layer of optical elements wherein the first layer of optical elements defines a plurality of undulations on the second layer of binder, and applying a second layer of optical elements onto the second layer of binder to partially embed the second layer of optical elements in the second layer of binder wherein the second layer of optical elements has an exposed-lens surface portion and an embedded-lens surface portion.

It is to be understood that both the foregoing general description and the following detailed description are exemplary, but are not restrictive, of the invention.

### BRIEF DESCRIPTION OF THE DRAWINGS

The invention may be best understood from the following detailed description when read in connection with the accompanying drawings. Included in the drawings are the following figures:

FIG. 1 is a cross section of an illustrative substrate marking system of the present invention; and

FIG. 2 is a block diagram of a method for making a substrate marking according to the present invention.

### DETAILED DESCRIPTION OF THE INVENTION

The present invention is directed to reflective surface marking systems, reflective elements and methods of applying a reflective marking system to a substrate. Reflective marking systems according to the present invention include a first layer of binder, a first layer of optical elements partially embedded in the first layer of binder, a second layer of binder covering the first layer of optical elements, and a second layer of optical elements partially embedded in the second layer of binder. An assembly according to the present invention includes a glass microsphere core member with a generally spherical periphery and an adherent coating comprising at least one layer of binder extending over the entire periphery of the core member and a layer of light-returning glass microspheres partially embedded in the binder in a substantially hemispherical arrangement. Methods of applying a reflective marking to a substrate according to the present invention include applying a first layer of binder, applying a first layer of optical elements onto the first layer of binder, applying a second layer of binder onto the first layer of optical elements, and applying a second layer of optical elements onto the second layer of binder.

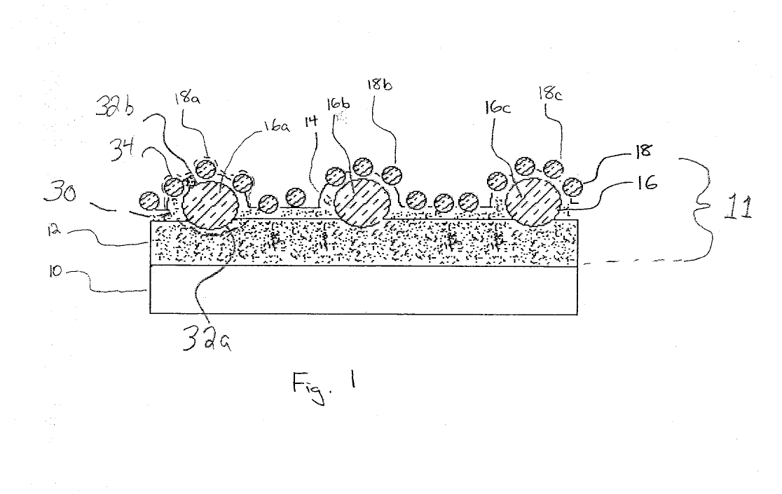

FIG. 1 shows a reflective marking system 11 according to one embodiment of the present invention. Substrate 10 can be any surface or portion of a surface for which it is desirable to enhance visibility, especially one to which first layer 12 of binder will adhere. Thus, substrate 10 may be asphalt in a highway application, metal in the case of a traffic sign or guard rail, or other material. While not shown, the marking system of the present invention could be laid over a previously-applied layer or substrate 10, such as a layer of tape.

First layer 12 of binder is generally liquid initially and may adhere to the substrate by mechanical means in which the first layer of binder works its way into small pores of the substrate, by chemical means in which a chemical bond may occur between the substrate and the first layer of binder, or by a combination of both chemical and mechanical means. For example, some binders may chemically bond to a concrete primer, but may not bind to an asphalt primer. Preferably, the first layer of binder is selected for its compatibility with the substrate material. An important characteristic of first layer 12 of binder is the strength with which it binds to the substrate (or a primer over the substrate). A reflective marking system incorporating a strong binder on a weak asphalt surface, for example, may quickly degenerate as traffic impacts the marking and rips away large portions of asphalt and marking alike.

The binders used herein may be any commonly acceptable durable binder which afford the desired characteristics such as substrate compatibility and binding strength. Preferably, the binder lasts more than one year of typical usage. The binders typically include a resin and a pigment. Typically, binders suitable for use in the present invention are epoxy, polyurea, methyl methyacrylate, polyurethane, water-based paint, and spray thermoplastic, among others suitable for use as a pavement marking material.

It is desirable that the first layer of binder have sufficient pigmentation to achieve the desired retroreflectivity. In a highway application, for example, the first layer of binder will often contain a white or yellow pigment. Eventually, traffic will erode the reflective marking system to the point that first layer optical element 16a is visible. Light will then impinge upon the now exposed lens of first layer optical element 16a. This light is refracted towards the base of the first layer optical element, where it is reflected back towards the light source by the pigment of the first layer of binder. The pigmentation in the first layer of binder allows the light to reflect back through the first layer optical element 16a.

The thickness of first layer 12 of binder depends to an extent upon the vertical height of first layer 16 of optical elements 16a-16c. The thickness of first layer of binder should preferably be great enough to embed sufficient vertical height of the first layers of optical elements therein. In a highway application, a minimum thickness of 7 mils to 15 mils is desirable for the first layer of binder. More preferably, the thickness for the first layer of binder ranges from 10 mils to 12 mils.

The first layer 16 of optical elements 16a-16c may be glass microspheres. In a highway application, the glass microsphere used as first layer optical elements 16a, 16b, or 16c should preferably have a diameter within the range of 1,000 microns to 4,000 microns. More preferably, the glass microsphere used as the first optical element should have a diameter within the range of 1,000 microns to 2,000 microns. In this application, diameters of glass microspheres are expressed as median diameters.

First layer optical elements 16a-16c are deposited in first layer 12 of binder while it is in a wet or tacky state. Depending on the type of-binder and the size of the first layer optical element, a buoyant effect may be observed where the first layer 16 of optical elements does not fully sink into first layer 12 of binder, leaving exposed a portion of the vertical diameters of first layer optical elements 16a, 16b, and 16c. This buoyant effect results from the surface tension of the first layer of binder. Certain binders, such as thermoplastic, may have such a degree of surface tension as to require forceful application of the first layer optical elements in order to reach the desired embedment. Preferably, a buoyant effect between first layer 16 of optical elements 16a-16c and first layer 12 of binder is present to some extent, namely to aid in achieving the desired embedment, and counteract the force by which the optical elements strike the first layer 12 of binder.

In the embodiment shown in FIG. 1, a portion of the vertical diameter of first layer 16 of optical elements 16a-16c is embedded into the first layer of binder before it solidifies and cures. Ample vertical diameter should be embedded to allow the first layer optical element to adequately resist displacement from the first layer of binder due to abrasion or friction. But, sufficient vertical diameter should remain exposed in order to provide both an undulating surface for the upper layers of the reflective marking system and a desirable amount of reflectivity once abrasion and friction erode the reflective marking system to expose the first layer of optical elements. Embedding 10 to 60% of the vertical diameter of the first layer optical element into the first layer of binder has been found to be preferable. More preferably, 20 to 30% of the vertical diameter is embedded into the first layer of binder. As used herein, the term “vertical diameter” means that diameter extending through the first layer optical element 16a-16c and perpendicular to the plane of substrate 10.

In highway applications, the first layer optical elements 16a-16c preferably have a refractive index of at least about 1.5. More preferably, the first layer optical elements have a refractive index of at least about 1.9. Suitable glass microspheres for use as the first layer optical elements in the embodiments described herein include beads meeting Federal Highway Administration Specification FP-96, Table 718-2 (2003), commercially available from Potters Industries, Inc. of Malvern, Pa.

Preferably, a second layer 14 of binder substantially covers the first layer 16 of optical elements. The second layer of binder is drawn from the same available choices for the first layer of binder. Furthermore, the second layer of binder may be composed of the same material as the first layer of binder in a given marking system. The second layer of binder may alternatively be composed of a material different from the first layer of binder in a given marking system. Generally, it is preferable that the pigment of the second layer of binder match that of, and adhere to, the first layer of binder.

It is desirable for the first layer optical of elements to define a plurality of undulations in the second layer of binder. These undulations permit light to impinge on second layer 18 of optical elements 18a-18c at a variety of angles, providing enhanced retroreflectivity in a variety of conditions. An excessive application of the second layer of binder (so much that it fills the valleys between the optical elements 16a-16c) should be avoided as this would result in a surface devoid of undulations. In a highway application, a normal thickness for the second layer of binder ranges between 4 mils to 10 mils, preferably 5 mils to 8 mils. Preferably, for highway applications, the sum of the thicknesses of the two layers of binder is between 15 mils to 20 mils, and the thickness of the second layer 14 of binder varies between 20% -50%, preferably 30-40%, of the first layer 12 of binder.

The optical elements 18a-18c of second layer 18 are smaller in diameter than optical elements 16a-16c of first layer 16. Preferably, the diameter of the optical element 16a-16c range from 3 to 10 times the diameter of optical elements 18a-18c of second layer 18. In one highway application, glass microspheres with diameters ranging from 50 to 600 microns, preferably 100 to 200 microns, are suitable for the second layer optical elements. Suitable glass microspheres for use as the second layer optical elements in the embodiments described herein include beads meeting Federal Highway Administration Specification TT-B-1325, Table 1, version C (1993), commercially available from Potters Industries, Inc. of Malvern, Pa.

In the embodiment shown in FIG. 1, a portion of the vertical diameter of second layer beads 18a-18c are embedded into the second layer of binder before it solidifies and cures. Sufficient vertical diameter should remain exposed in order enhance retroreflectivity. On the other hand, ample vertical diameter should be embedded to allow the second layer optical elements to adequately resist displacement from the second layer of binder due to abrasion or friction. Yet excessive embedment into the second layer of binder will lower retroreflectivity. Embedding 20 to 50% of the vertical diameter of the second layer optical element into the second layer of binder has been found to be preferable. More preferably, 30 to 45% of the vertical diameter is embedded into the second layer of binder. As used herein in connection with the second layer optical elements, the term “vertical diameter” means that diameter extending through the second layer optical element 18a-18c and perpendicular to the tangent line of the first optical element 16a-16c where that second layer optical element 18a-18c intersects that first optical element.

Microsphere-based optical systems used in the present invention utilize the light bending and a focusing effect to refract light onto a reflective surface, causing a portion of the light to reflect back towards its origin. The degree of refraction depends upon the relative refractive indices of the exposed microspheres and any interfering material between the exposed microsphere and the source of light.

It has been found that retroreflectivity in dry conditions increases as the refractive index of the glass bead increases, up to a refractive index of 1.9. Therefore, in an embodiment for use primarily in dry conditions, the refractive index of the second layer glass beads is preferably at least 1.5, more preferably at least 1.8, and most preferably about 1.9. In the case of highway marking systems, a film of water may cover the exposed microspheres after rainfall, lowering the effective refractive index for the highway marking system. To combat any dampening of the effective refractive index, it is preferable in highway applications that the second layer optical elements have a refractive index of at least about 1.9. While it appears that the best refractive index is achieved, it has been found that retroreflectivity in wet conditions provided by glass beads having a refractive index of 2.1 is greater than that provided by glass beads having a refractive index of 1.9. In an embodiment of the invention for use in alternating dry and wet conditions, a blend of glass beads having different refractive indeces (e.g., 1.9 and 2.1) is used. Preferably, the two sets of glass beads are applied in a manner to provide individual, linear stripes.

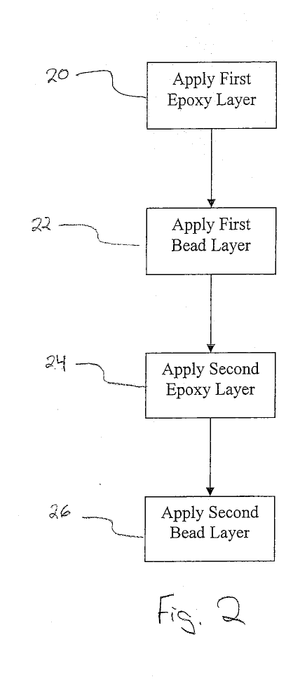

According to another exemplary embodiment of the invention, FIG. 2 shows a method for coating a surface of a substrate to improve the visibility of the surface. The surface could have been coated with a previous layer, such as a primer or tape. First step 20 involves applying a first layer of binder to the surface of the substrate. In a highway application, typical first layer binders include epoxy, polyurea, methyl methyacrylate, polyurethane, water-based paint, and spray thermoplastic, and other paints. The first layer of binder preferably has some appreciable pigmentation.

The first layer of binder is generally applied in liquid form and adheres to the surface of the substrate through mechanical means, chemical means, or a combination of both. The composition of the substrate is a factor in detecting the material used for first layer binders. For example, the ideal binder for binding to an asphalt substrate may differ from that for binding to a metal substrate. The desired bond strength may also influence the binder chosen to serve as the first layer of binder.

In first step 20, it is desirable to achieve a thickness of the first layer of binder sufficient to retain the optical elements applied in second step 22. In a certain highway applications, it is desirable to achieve a minimal thickness of 7 mils to 15 mils. Preferably, the minimal thickness for the first layer of binder in a highway application ranges from 10 mils to 12 mils.

In second step 22, a first layer of optical elements is applied to the first layer of binder while it is in a wet or tacky state. In some embodiments, the optical elements applied in the second step may be glass microspheres. In a preferred highway application, the glass microspheres applied in second step 22 have a diameter within the range of 1,000 microns to 4,000 microns. More preferably, the glass microspheres have a diameter within the range of 1,000 microns to 2,000 microns. In such an application, it is also desirable that the glass microsphere have a refractive index of at least about 1.5. Preferably, the glass microsphere should have a refractive index of at least about 1.9.

The combination of certain first layer binders and certain optical elements may result in a buoyant effect where the first layer optical elements do not fully sink into the first layer of binder. This buoyant effect is desirable and creates an undulating surface where a portion of the vertical height of the first layer optical elements remains unembedded in the first layer of binder. Preferably, a portion of the vertical height of the first layer optical elements is embedded into the first layer of binder before the binder solidifies and cures. Depending on factors such as the surface tension of the binder and the density of the optical elements, the application of the first layer of optical elements to the first layer of binder in second step 22 may require more or less force to reach the desired embedment.

In a highway application using glass microspheres, it is preferable to embed 10 to 60% of the vertical diameter of the glass microsphere into the first layer of binder. More preferably, 20 to 30% of the vertical diameter of the glass microsphere is embedded into the first layer of binder. This provides a solid bond between the glass microsphere and the first layer of binder such that traffic impacting the reflective marking will not easily dislodge the glass microspheres. However, this further acknowledges that embedding too much of the glass microsphere will avoid the formation of the undulating surface, which is desirable.

In third step 24, a second layer of binder is applied to the top of the bead-binder matrix, preferably after the first layer of binder has been allowed to fully cure. It is preferable that the second layer of binder substantially cover the first layer of optical elements. The second layer of binder may be any of the compositions discussed in first step 20. In a preferred embodiment, the second layer of binder is the same as the first layer of binder, including having the same color thereof. The second layer of binder may also be different from, but complimentary to, the first layer of binder in that it chemically assists with the curing process. It is often desirable that the pigment of the second layer of binder match that of the first layer of binder.

In a preferred embodiment, the first layer of optical elements defines a plurality of distinct undulations in the second layer of binder. An excessive application of the binder applied in third step 24 would minimize or eradicate this desirable undulating characteristic. Generally, the thickness of the binder applied in third step 24 depends upon the diameter of the optical elements applied in fourth step 26. In the preferred highway application, binder is applied to a thickness ranging between 4 mils to 10 mils, preferably 5 mils to 8 mils in third step 24.

In fourth step 26, a second layer of optical elements is applied to the undulating matrix created by the previous steps. The second layer optical elements are preferably smaller than the first layer optical elements. Preferably, the first layer optical element ranges from 3 to 10 times the size of the second layer optical element. In the preferred highway application, fourth step 26 includes the application of glass microspheres with diameters ranging from 50 to 600 microns, preferably from 100 to 200 microns. The refractive index of the glass microspheres applied in the fourth step is preferably at least about 1.5, more preferably at least about 1.8, and most preferably about 1.9 for primarily dry conditions. In an embodiment of the invention for use in alternating dry and wet conditions, a blend of glass beads having different refractive indeces (e.g., 1.9 and 2.1) is used.

Thus, a reflective assembly adapted for being adhered to a substrate 10 is formed by the method of the present invention. The assembly can be viewed as a region 30 around optical element 16a, which can also be viewed as a glass microsphere core member. As shown in the figures, optical element 16a has a generally spherical periphery. The assembly also includes an adherent coating comprising the first layer 12 of binder and a second layer 14 of binder. The first layer extends over a first portion 32a of the periphery of the core member (namely some percentage of the portion oriented as the bottom portion as viewed in FIG. 1). The second layer 14 of binder extends over a second portion 32b of the periphery of the core member (namely the remaining percentage of the portion of the periphery, including the top portion as viewed in FIG. 1). Because the second portion is the remainder of the periphery of the first portion, the periphery can be the to consist solely of the first portion and the second portion. Consequently, the core member 16a has substantially no exposed-lens surface portion. The coating further comprises a plurality of optical elements 18a in the form of light-returning glass microspheres. As mentioned above, elements 18a are smaller in diameter than the core member, are partially embedded only in the second layer of binder, and have an exposed-lens surface portion 34.

It is desirable that the undulating surface characteristic of the bead-binder matrix remain preserved after the addition of the optical elements in the fourth step. In the highway application, up to about 40% of the vertical diameters of the second layer glass microspheres are embedded in the second layer of binder. The second layer optical elements are bound to the matrix by the second layer of binder at both the “peaks” created by the underlying first layer optical elements and the “valleys” between underlying first layer optical elements. Several second layer glass microspheres may be bound to a single peak in an undulating manner. These undulations permit light to impinge the second layer optical elements at a variety of angles, providing enhanced retroreflectivity in a variety of conditions.

The method can be carried out using any suitable commercially available application system. A single vehicle is preferably used to carry out all four steps, but any combination of up to four vehicles can be used.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A marking system adapted for coating a surface of a substrate comprising:
a) a first layer of binder having a top surface and a bottom surface, wherein said bottom surface is adapted for binding to the surface of the substrate;
b) a first layer of optical elements in which said first layer of optical elements is partially embedded in said top surface of said first layer of binder;
c) a second layer of binder having a top surface and a bottom surface in which said bottom surface of said second layer of binder covers said first layer of optical elements, wherein said first layer of optical elements defines a plurality of undulations in said second layer of binder; and
d) a second layer of optical elements in which said second layer of optical elements is partially embedded in said top surface of said second layer of binder and has an exposed-lens surface portion.

2. The marking system of claim 1, wherein the optical elements are glass microspheres.

3. The marking system of claim 1, wherein the first layer of binder has a thickness which is within the range of 7 to 15 mils.

4. The marking system of claim 2, wherein the glass microspheres of the first layer have a diameter which is within the range of 3 to 10 times larger than that of the glass microspheres of the second layer.

5. The marking system of claim 2, wherein the glass microspheres of the first layer have an index of refraction of at least about 1.5 and the glass microspheres of the second layer have an index of refraction of at least about 1.9.

6. The marking system of claim 2, wherein the glass microspheres of the first layer have a diameter within the range of 1,000 to 4,000 microns and the glass microspheres of the second layer have a diameter within the range of about 50 to 600 microns.

7. The marking system of claim 2, wherein between about 10% to 60% of the vertical diameter of the glass microspheres of the first layer is submerged in the first layer of binder.

8. The marking system of claim 1, wherein the first and second layers of binder are selected from the group consisting of epoxy, polyurea, methyl methyacrylate, polyurethane, water-based paint, and spray thermoplastic.

9. The marking system of claim 8, wherein the first and second layers of binder comprise the same material.

10. The marking system of claim 8, wherein the first and second layers of binder comprise different materials.

11. The marking system of claim 2, wherein the glass microspheres of the first layer have an index of refraction of at least about 1.5 and the glass microspheres of the second layer comprise a blend of a first set of beads having an index of refraction of about 1.9 and a second set of beads having an index of refraction of about 2.1.

12. A reflective assembly adapted for being adhered to a substrate, said assembly comprising a glass microsphere core member having a generally spherical periphery, and an adherent coating comprising a first layer of binder extending over a first portion of the periphery of the core member and a second layer of binder extending over a second portion of the periphery of the core member, wherein the periphery consists of the first portion and the second portion, wherein said core member has substantially no exposed-lens surface portion, said coating further comprising a plurality of light-returning glass microspheres, smaller in diameter than the core member, and partially embedded only in said second layer of binder and having an exposed-lens surface portion.

13. The assembly of claim 12, wherein the glass microsphere core member has an index of refraction of at least about 1.5 and the light-returning glass microspheres comprise a blend of a first set of beads having an index of refraction of about 1.9 and a second set of beads having an index of refraction of about 2.1.

14. A method for coating a surface of a substrate to improve the visibility of the surface comprising the steps of:
a) applying a first layer of binder to the surface of the substrate;
b) applying a first layer of optical elements onto said first layer of binder to partially embed said first layer of optical elements in said first layer of binder, wherein said first layer of optical elements has an exposed-lens surface portion and an embedded-lens surface portion;
c) applying a second layer of binder to said first layer of optical elements to cover said exposed-lens surface portion of said first layer of optical elements, wherein said first layer of optical elements defines a plurality of undulations in said second layer of binder; and
d) applying a second layer of optical elements onto said second layer of binder to partially embed said second layer of optical elements in said second layer of binder wherein said second layer of optical elements has an exposed-lens surface portion and an embedded-lens surface portion.

15. The method of claim 14, wherein the first layer of binder is applied to a thickness which is within the range of 7 to 15 mils.

16. The method of claim 14, wherein the optical elements are glass microspheres.

17. The method of claim 16, wherein the glass microspheres of the first layer have a diameter which is within the range of 3 to 10 times larger than that of the glass microspheres of the second layer.

18. The method of claim 16, wherein the glass microspheres of the first layer have a diameter within the range of 1,000 to 4,000 microns and the glass microspheres of the second layer have a diameter within the range of about 50 to 600 microns.

19. The method of claim 16, wherein the glass microspheres of the first layer have an index of refraction of at least about 1.5 and the glass microspheres of the second layer have an index of refraction of at least about 1.9.

20. The method of claim 16, wherein between about 10% to 60% of the vertical diameter of the glass microspheres of the first layer is submerged in the first layer of binder.

21. The method of claim 14, wherein the first and second layers of binder are selected from the group consisting of epoxy, polyurea, methyl methyacrylate, polyurethane, water-based paint, and spray thermoplastic.

22. The method of claim 21, wherein the first and second layers of binder comprise the same material.

23. The method of claim 21, wherein the first and second layers of binder comprise different materials.

24. The method of claim 16, wherein the glass microspheres of the first layer have an index of refraction of at least about 1.5 and the glass microspheres of the second layer comprise a blend of a first set of beads having an index of refraction of about 1.9 and a second set of beads having an index of refraction of about 2.1.
